(19) United States
(12) Patent Application Publication
(10) Pub. No.: US 2004/0042801 A1
(43) Pub. Date: Mar. 4, 2004

(54) Electronic equaliser for optical transmitter

(75) Inventor: Berthold Wedding, Munchingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/628,514

(22) Filed: Jul. 29, 2003

(30) Foreign Application Priority Data
Aug. 30, 2002 (EP) 02 360 249.3

(51) Int. Cl. H04B 10/04

(52) U.S. Cl. 398/193; 398/194

(57) ABSTRACT

Part of the invention is a method for electronic equalizing an optical transmitter comprising the following steps.

In a first step an electronic signal is split in a first electronic signal and a second electronic signal. In a next step one of the signals, being split, is delayed. The signals are then combined, wherein one signal is attenuated. The so combined signal is passed to the optical transmitter.

### The invention is based on a priority application EP 02 360 249.3 which is hereby incorporated by reference.

### TECHNICAL FIELD OF THE INVENTION

The present invention relates generally to a method for electronic equalizing an optical transmitter.

### PRIOR ART

The state of the art comprises a well known modulator driver amplifier with slope compensation, e.g. Amplifier SHF 806P from SHF Communication Technologies AG with a positive gain slope option up to 3 dB.

The U.S. Ser. No. 2002/0054726 discloses a method of modifying the spectral distribution of an optical signal including the steps of splitting the signal among a plurality of optical paths, delaying the propagation of the optical signal through one or more of the optical paths by a time duration and then recombining those optical outputs.

### BACKGROUND OF THE INVENTION

The equalization of the frequency-response of electro-optical transmitter devices, especially of external optical modulators (e.g. LiNbO3) at high bit rates (e.g. 43 Gbit/s), due to the following problem: The modulator usually shows a low-pass behavior.

### SUMMARY OF THE INVENTION

It is therefore an object of the present invention to provide a method for electronic equalizing an optical transmitter avoiding the low-pass behavior described above. This can be equalized by a suitable high-pass filter.

The present invention recognizes the possibility that all of mentioned functions can be performed by substantially the same circuitry.

### DETAILED DESCRIPTION

Part of the invention is a method for electronic equalizing an optical transmitter comprising the following steps.

In a first step an electronic signal is split in a first electronic signal and a second electronic signal. In a next step one of the signals, being split, is delayed. The signals are then combined, wherein one signal is attenuated. The so combined signal is passed to the optical transmitter.

The peak-frequency of the optical transmitter is adjusted with the delay of the delayed signal and the amount of the peak-frequency is adjusted with the degree of attenuation.

The preferred embodiments of the invention are set forth in the dependent claims.

In the first preferred embodiment the splitting is done by an amplifier. Other splitting devices may also be used. Furthermore the combining of the first electronic signal and the second electronic signal is done by a power combiner. The combining can also be achieved by a directional coupler.

An other part of the present invention is a circuitry implementing the above mentioned method. In the preferred embodiment the circuitry for electronic equalizing an optical transmitter comprises a splitter splitting an electronic signal in a first electronic signal and a second electronic signal, means for delaying one of said first signal or said second signal, means for combining said first signal and said second signal, wherein one signal is attenuated, and an optical transmitter being influenced by said combined signal.

The technical implementations have been described above. The means for delaying one of said first signal or said second signal are electrical transmission lines.

The invention improves the optical output signals of the transmitter, leading to a better performance of the transmission system. Another advantage is that the signals can be transmitted over a longer distance. Both signals of a differential stage are used to increase the output amplitude at high frequencies.

Although no multiple referenced claims are drawn, all reasonable combinations of the features in the claims shall be disclosed.

### DESCRIPTION OF THE DRAWINGS

For a more complete understanding of the present invention, reference is established to the following description made in connection with accompanying drawings in which:

FIG. 1 shows a principle schema of an electronic equalizer for optical transmitter; (can also be used as hybrid realisation of the principle)

FIG. 2 shows an alternative hybrid embodiment using microwaves components;

FIGS. 3a-b show two possible embodiments, that can be integrated using an on-chip delay line.

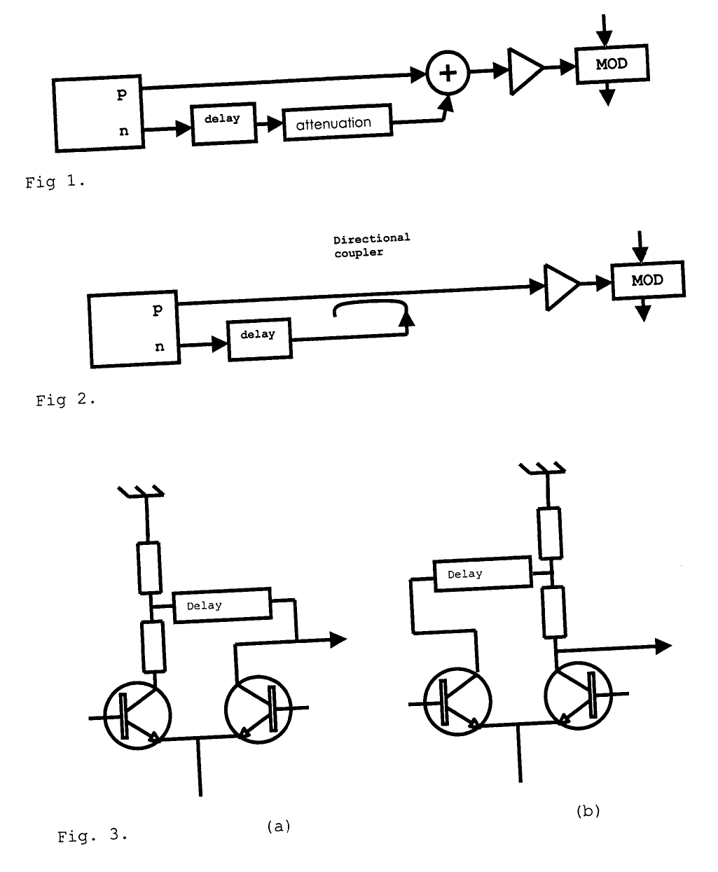

FIG. 1 shows a principle schema of an electronic equalizer for an optical transmitter. Two electronic signals p and n of a differential output stage (e.g. of a 43 Gbit/s multiplexer) are combined e.g. with a power combiner. One signal, here e.g. signal n, is delayed and attenuated. The peak-frequency of the equalizer is adjusted with the delay line. A delay that corresponds to a phase retardation of Pi Rad is required for the peak frequency. The amount of peaking is adjusted with the attenuation in one signal path.

FIG. 2 shows an alternative hybrid realization using microwaves components, wherein the signals are combined by a directional coupler. A high output voltage can by achieved due to the low insertion loss of the directional coupler (typically <2 dB in comparison with the power combiner with insertion loss of 6 dB).

FIG. 3a, FIG. 3b show the out put stage of a differential amplifier, where the delay line as well as the means for attenuation of one signal (here signal “n”) is also integrated. This version is advantageous for a fully integrated realisation since the delay line can also be integrated as a transmission line on the chip.

1. A method for electronic equalizing an optical transmitter comprising the steps:
splitting an electronic signal in a first electronic signal and a second electronic signal,
delaying one of said first signal or said second signal,
combining said first signal and said second signal, wherein one signal is attenuated,
using said combined signal, to drive the optical transmitter.

2. The method according to the previous claim, wherein said first electronic signal and the second electronic signal are combined with a power combiner.

3. The method according to claim 1, wherein said first electronic signal and the second electronic signal are combined with a directional coupler.

4. The method according to claim 1, wherein the peak-frequency is adjusted with the delay of said delayed signal.

5. The method according to claim 1, wherein the amount of the peak-frequency is adjusted with the degree of attenuation.

6. The method according to claim 1, wherein the splitting is done by an amplifier.

7. A circuitry for electronic equalizing an optical transmitter comprising
a splitter splitting an electronic signal in a first electronic signal and a second electronic signal,
means for delaying one of said first signal or said second signal,
means for combining said first signal and said second signal, wherein one signal is attenuated,
an optical transmitter being influenced by said combined signal.

8. The circuitry according to the previous circuitry claim, wherein the means for combining said first electronic signal and the second electronic signal is a power combiner or a directional coupler.

9. The circuitry according to claim 7, wherein the peak-frequency is adjusted with the delay of said delayed signal and/or wherein the peak-frequency is adjusted with the degree of attenuation.

10. The circuitry according to claim 7, wherein the splitter is an amplifier.

11. The circuitry according to claim 7, wherein the means for delaying one of said first signal or said second signal is an electronic delay line integrated on a chip together with the amplifier.

12. An apparatus for electronic equalizing an optical transmitter comprising a circuitry according to one or more of the previous circuitry claims.
